(19) United States
(12) Patent Application Publication
(10) Pub. No.: US 2018/0171157 A1
(43) Pub. Date: Jun. 21, 2018

(54) SURFACE TOPOGRAPHIES FOR NON-TOXIC BIOADHESION CONTROL

(71) Applicants: UNIVERSITY OF FLORIDA RESEARCH FOUNDATION, INC., GAINESVILLE, FL (US); SHARKLET TECHNOLOGIES, INC., Aurora, CO (US)

(72) Inventors: Chelsea Marie MAGIN, Denver, CO (US); Shravanthi T. REDDY, Goleta, CA (US); Anthony B. BRENNAN, Gainesville, FL (US)

(73) Assignees: UNIVERSITY OF FLORIDA RESEARCH FOUNDATION ,INC., Gainesville, FL (US); SHARKLET TECHNOLOGIES , INC., Aurora, CO (US)

(21) Appl. No.: 15/578,367

(22) PCT Filed: Jun. 3, 2016
(86) PCT No.: PCT/US2016/035694

§ 371 Date: Nov. 30, 2017

Related U.S. Application Data
(60) Provisional application No. 62/170,342, filed on Jun. 3, 2015.

(51) Int. Cl. C09D 5/16; G01J 3/42; C03C 3/078; C08L 87/00; C08L 57/00

(52) U.S. Cl. CPC C09D 5/1637; C09D 5/1618; G01J 3/42; C08L 83/04; C08L 87/00; C08L 57/00; C03C 3/078

(57) ABSTRACT

An article has a surface topography for resisting bioadhesion of organisms and includes a base article having a surface. A composition of the surface includes a polymer. The surface has a topography comprising a pattern defined by a plurality of spaced apart features attached to or projected into the base article. The plurality of features each have at least one microscale dimension and at least one neighboring feature having a substantially different geometry, wherein neighboring patterns share a common feature. The surface has an optical transmission at 400 nm to 700 nm of equal to or greater than 70%. In one embodiment, the surface can comprise a coating layer disposed on the base article.

### FIELD OF THE INVENTION

The invention relates to articles and related devices and systems having surface topography and/or surface elastic properties for providing non-toxic bioadhesion control.

### BACKGROUND

Environmental surfaces are often contaminated with microorganisms. These organisms can be deposited onto a surface via touch transfer from another contaminated surface or via airborne organisms that settle and attach to the surface. Contamination of environmental surfaces can spread disease, thereby becoming a burden to human health. Surfaces can be disinfected using toxic agents including bleach, ammonia, and other common cleaners. However, the surface is susceptible to re-contamination between cleanings.

The accumulations of bacteria, i.e. a biofilm, on implanted devices such as catheters present a significant risk of infection leading to complications as severe as death. Bacterial contamination is also a problem for materials utilized in optical applications in which certain light transmission properties are desired.

### SUMMARY OF THE INVENTION

An article has a surface topography for resisting bioadhesion of organisms and includes a base article having a surface. A composition of the surface includes a polymer. The surface has a topography comprising a pattern defined by a plurality of spaced apart features attached to or projected into the base article. The plurality of features each have at least one microscale dimension and at least one neighboring feature having a substantially different geometry, wherein neighboring patterns share a common feature. The surface has an optical transmission at 400 nm to 700 nm of equal to or greater than 70%. In one embodiment, the surface can comprise a coating layer disposed on the base article. In another embodiment, the surface can be a part of the base article.

Surface topographies resist contamination as compared to the base article. As used herein, a surface that provides a surface topography can be applied to a surface as either a printed patterned, adhesive coating containing the topography, or applied directly to the surface of the device through micromolding. In the case of micromolding, the surface topography will be monolithically integrated with the underlying article.

The feature spacing distance as used herein refers to the distance between adjacent features. Moreover, as used herein, “microscale features” includes micron size or smaller features, thus including microscale and nanoscale. In one embodiment referred to as a hierarchical architecture, at least one multi-element plateau layer is disposed on a portion of the surface. A spacing distance between elements of the plateau layer provides a second feature spacing being substantially different as compared to the first feature spacing. The hierarchical architecture can simultaneously repel organisms having substantial different sizes, such as spores and barnacles. In one embodiment the surface is monolithically integrated with the base article, wherein a composition of the base article is the same as the composition of the surface. In another embodiment, the surface comprises a coating layer disposed on the base article. In this coating embodiment, the composition of the coating layer is different as compared to a composition of the base article, and the polymer can comprise a non-electrically conductive polymer, such as selected from thermoplastic polymers, elastomers, rubbers, polyurethanes, polysulfones, polyacrylates, for example a polyacrylate coating layer on a vinyl and/or Polyethylene terephthalate (PET) substrate or base article.

The topography can provide an average roughness factor (R) of from 4 to 50 and an elastic modulus of between 10 kPa and 3 GPa. In another embodiment, the topography is numerically representable using at least one sinusoidal function, such as two different sinusoidal waves. An example of a different sinusoidal wave topography comprises a Sharklet topography. In another embodiment, the plurality of spaced apart features can have a substantially planar top surface. In a preferred embodiment for limiting bacterial contamination, the first feature spacing can be between 2 and 60 μm.

In the multi-element plateau layer disposed on a portion of surface embodiment, wherein a spacing distance between elements of the plateau layer provide a second feature spacing being substantially different as compared to the first feature spacing, the surface can comprise a coating layer disposed on the base article. The elastic modulus of the coating layer can be between 10 kPa and 3 GPa.

In an embodiment, the base article may comprise an optically transparent material having a light transmission greater than or equal to 80%. The base article may comprise a metal oxide that is optically transparent having a surface that is patterned with the texture.

The base article can comprise an optical device for applications having particular light transmission properties.

### BRIEF DESCRIPTION OF THE DRAWINGS

A fuller understanding of the features and benefits thereof will be obtained upon review of the following detailed description together with the accompanying drawings, in which:

FIG. 1A is a scanned SEM image of an exemplary “Sharklet” anti-microorganism surface topography comprising a plurality of raised surface features which project out from the surface of a base article, according to an embodiment of the invention.

FIG. 1B is a scanned optical profilometry image of a pattern having a plurality of features projecting into the surface of a base article, according to another embodiment of the invention.

FIG. 2A illustrates an exemplary surface architectural patterns according to the invention;

FIG. 2B illustrates another exemplary surface architectural patterns according to the invention;

FIG. 2C illustrates yet another exemplary surface architectural patterns according to the invention;

FIG. 2D illustrates yet another exemplary surface architectural patterns according to the invention;

FIG. 3 provides a table of exemplary feature depths, feature spacings, feature widths and the resulting roughness factor (R) based on the patterns shown in FIGS. 2(a)-(d).

FIG. 4A is a scanned SEM image of an exemplary “Sharklet” anti-microorganism surface topography comprising a plurality of raised surface features which project out from the surface of a base article, according to an embodiment of the invention.

FIG. 4B is a depiction of an exemplary hierarchical surface topography according to an embodiment of the invention.

FIG. 5A shows a sinusoidal wave beginning at the centroid of the smallest (shortest) of the four features comprising the Sharklet pattern.

FIG. 5B shows sine and cosine waves describing the periodicity and packing of the Sharklet pattern.

FIG. 6A shows two (of four) exemplary Sharklet elements, element 1 and element 2; and FIG. 6B shows the resulting layout between two elements by setting the spacing to 3 microns.

FIG. 7A shows a space filled with elements defined by limitations imposed;

FIG. 7B shows the result of applying sinusoidal waves to define periodic repeat definitions,

FIG. 7C shows the resulting topographical structure over the full area of the desired surface.

FIG. 8 is a first assay of the average log density of Staphylococcus aureus contamination from a contaminated cloth on samples having either a smooth surface topography or the Sharklet pattern surface topography. The Sharklet surface topography has a 2×2 pattern where the width of the features is 2 μm and the distance between the features is 2 μm (SK2×2). The depth of each feature was 3 μm. The sample surfaces were prepared using acrylic, polypropylene, acrylonitrile butadiene styrene (ABS) or thermoplastic polyurethane (TPU). Error bars represent ±1 standard error.

FIG. 9 is a second assay of the average log density of Staphylococcus aureus (MSSA) or methicillin-resistant Staphylococcus aureus (MRSA) microbial attachment after incubating acrylic film samples having either a smooth surface topography or the Sharklet pattern surface topography in a bacterial suspension.

FIG. 10A is a third assay of the average log density of MSSA microbial persistence on the above-described acrylic film samples using a uniform spray inoculation technique.

FIG. 10B is a representative image of a RODAC contact plate after MSSA sampling according to the assay of FIG. 10A.

FIG. 11 is a fourth assay of the average log density of MSSA or MRSA microbial transfer and persistence on the above-described acrylic film samples as well as a copper foil sample using a uniform spray inoculation technique.

FIG. 12 is a first assay of the relative optical transmission in the visible light spectrum for different surface topographies as measured at 600 nm. Topographies used included a smooth surface with no pattern thereon (SM), a surface having a 10×2 pattern where the width of the features is 2 μm and the distance between the center points of adjacent features is 10 μm (SK10×2) and a surface having a 2×2 pattern where the width of the features is 2 μm and the distance between the features is 2 μm (SK2×2). Error bars represent ±1 standard error.

FIG. 13 is a second assay of the average total luminous transmittance for different surface topographies as measured according to ASTM D1003-13 Procedure B (Spectrophotometer Method). Topographies used included a control surface using an industry standard control material, a smooth surface with no pattern thereon (SM), a surface having a 10×2 pattern where the width of the features is 2 μm and the distance between the center points of adjacent features is 10 μm (SK10×2) and a surface having a 2×2 pattern where the width of the features is 2 μm and the distance between the features is 2 μm (SK2×2);

FIG. 14 is a third assay of the average diffuse transmittance for different surface topographies as measured according to ASTM D1003-13 Procedure B (Spectrophotometer Method). Topographies used included a control surface using an industry standard control material, a smooth surface with no pattern thereon (SM), a surface having a 10×2 pattern where the width of the features is 2 μm and the distance between the center points of adjacent features is 10 μm (SK10×2) and a surface having a 2×2 pattern where the width of the features is 2 μm and the distance between the features is 2 μm (SK2×2);

FIG. 15 is a fourth assay of the average haze for different surface topographies as measured according to ASTM D1003-13 Procedure B (Spectrophotometer Method). Topographies used included a control surface using an industry standard control material, a smooth surface with no pattern thereon (SM), a surface having a 10×2 pattern where the width of the features is 2 μm and the distance between the center points of adjacent features is 10 μm (SK10×2) and a surface having a 2×2 pattern where the width of the features is 2 μm and the distance between the features is 2 μm (SK2×2).

### DETAILED DESCRIPTION OF THE INVENTION

Disclosed herein is a variety of scalable surface topographies for modification of biosettlement i.e., bioadhesion, such as bioadhesion of biofouling organisms, including, but not limited to, algae, bacteria, fungus, molds and barnacles. As described in the Examples described below, it has been proven through experimental testing that surface topographies according to the invention provide a passive and non-toxic surface, which through selection of appropriate feature sizes and spacing, can significantly and generally dramatically reduce settlement and adhesion of the most common fouling microorganisms.

Although not required to practice the present invention, Applicants not seeking to be bound by the mechanism believed to be operable to explain the efficacy of the present invention, provide the following. The efficacy of surfaces according to the invention is likely to be due to physically interfering with the settlement and adhesion of microorganisms, such as algae, bacteria and barnacles. Properly spaced features (such as “ribs”) formed on or formed in the surface can be effective for organisms from small bacteria (<1 μm, such as 200 to 500 nm), to large tube worms (>200 μm, such as 200 to 500 μm), provided the feature spacing scales with the organism size. Various different surface topographies can be combined into a hierarchical multi-level surface structure to provide a plurality of spacing dimensions to deter the settlement and adhesion of multiple organisms having multiple and wide ranging sizes simultaneously, such as algae, spores and barnacles. In one embodiment, the feature spacing distance is larger than the dimension of the microorganism or cell to resist bioadhesion thereof.

Topographies according to the invention can generally be applied to a wide variety of surfaces for a wide variety of desired applications. Applications for inhibiting bioadhesion using the invention described in more detail below include base articles used in marine environments or biomedical or other applications which may be exposed to contamination by biological organisms, such as roofs on buildings, water inlet pipes in power plants, catheters, cosmetic implants, and heart valves. As described below, surfaces according to the invention can be formed on a variety of devices and over large areas, if required by the application. The topography can be raised from a surface of a base article (e.g., by embossing) or alternatively, be impressed into the surface of the base article (e.g., by compression molding).

Features according to the invention are generally raised surfaces (volumes) which emerge from a base level to provide a first feature spacing, or in the case of hierarchical multi-level surface structures according to the invention also include the a second feature spacing being the spacing distance between neighboring plateaus, which themselves preferably include raised features thereon or features projected into the base article.

Although the surface is generally described herein as being an entirely polymeric, the coating can include non-polymeric elements that contribute to the viscoelastic and topographical properties. A “feature” as used herein is defined a volume (L, W and H) that projects out the base plane of the base material or an indented volume (L, W and H) which projects into the base material. The claimed architecture is not limited to any specific length. For example, two ridges of an infinite length parallel to one another would define a channel in between. In contrast, by reducing the overall lengths of the ridges one can form individual pillars. Although the surface is generally described as a coating which is generally a different material as compared to the base article, as noted above, the invention includes embodiments where the coating and base layer are formed from the same material, such as provided by a monolithic design, which can be obtainable by micromolding.

In the case of a surface coating, the coating can comprise a non-electrically conductive material, defined as having an electrical conductivity of less than 1×10⁻⁶ S/cm at room temperature. The coating layer can comprise elastomers, rubbers, polyurethanes and polysulfones. The elastic modulus of the coating layer can be between 10 kPa and 3 GPa. In the case of 10 to 100 kPa materials, the coating can comprise hydrogels such as polyacrylic acid and thermo sensitive hydrogels such as poly isopropylacrylimide. The coating layer can be various thickness, such as 1 μm to 10 mm, preferably being between 100 μm to 1 mm.

Each of the features have at least one microscale dimension. In some embodiments, the top surface of the features are generally substantially planar.

Although feature spacing has been found to be the most important design parameter, feature dimensions can also be significant. In a preferred embodiment of the invention, each of the features include at least one neighboring feature having a “substantially different geometry”. “Substantially different geometry” refers to at least one dimension being at least 10%, more preferably 50% and most preferably at least 100% larger than the smaller comparative dimension. The feature length or width is generally used to provide the substantial difference.

The feature spacing in a given pattern should generally be consistent. Studies by the present Inventors have indicated that small variations in micrometer scale spacing of the ribs that compose the surface features have demonstrated that less than 1 μm changes (10% or less than the nominal spacing) can significantly degrade coating performance.

The composition of the patterned coating layer may also provide surface elastic properties which also can provide some bioadhesion control. In a preferred embodiment when bioadhesion is desired to be minimized, the coated surface distributes stress to several surrounding features when stress is applied to one of the features by an organism to be repelled from the surface.

The roughness factor (R) is a measure of surface roughness. R is defined herein as the ratio of actual surface area (Ract) to the geometric surface area (Rgeo); R=Ract/Rgeo). An example is provided for a 1 cm² piece of material. If the sample is completely flat, the actual surface area and geometric surface area would both be 1 cm². However if the flat surface was roughened by patterning, such as using photolithography and selective etching, the resulting actual surface area becomes much greater that the original geometric surface area due to the additional surface area provided by the sidewalls of the features generated. For example, if by roughening the exposed surface area becomes twice the surface area of the original flat surface, the R value would thus be 2.

The typography generally provides a roughness factor (R) of at least 2. It is believed that the effectiveness of a patterned coating according to the invention will improve with increasing pattern roughness above an R value of about 2, and then likely level off upon reaching some higher value of R. In a preferred embodiment, the roughness factor (R) is at least 4, such as 5, 6, 7, 8, 9, 10 11, 12, 13, 14, 15, 16, 17, 18, 19, 20, 25 or 30. Assuming deeper and more closely spaced features can be provided, R values can be higher than 30.

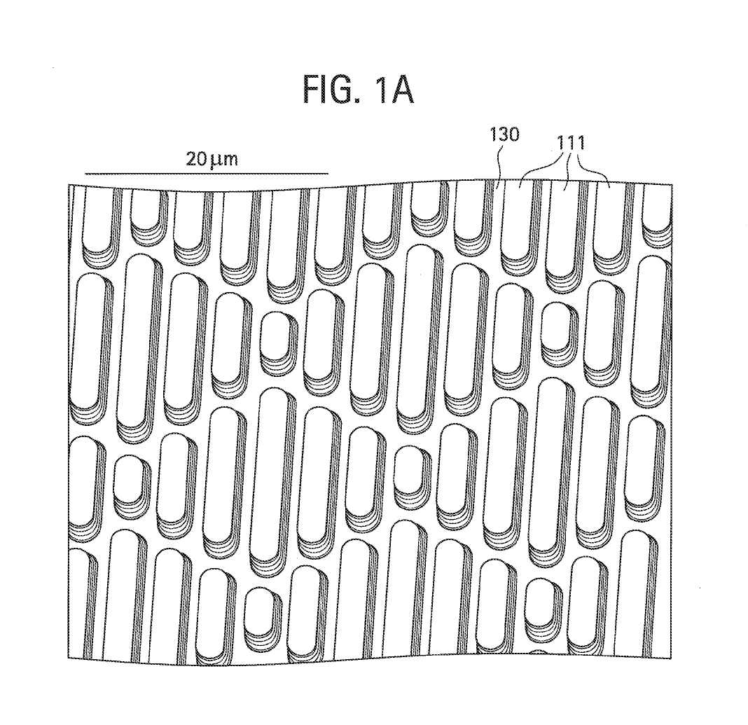

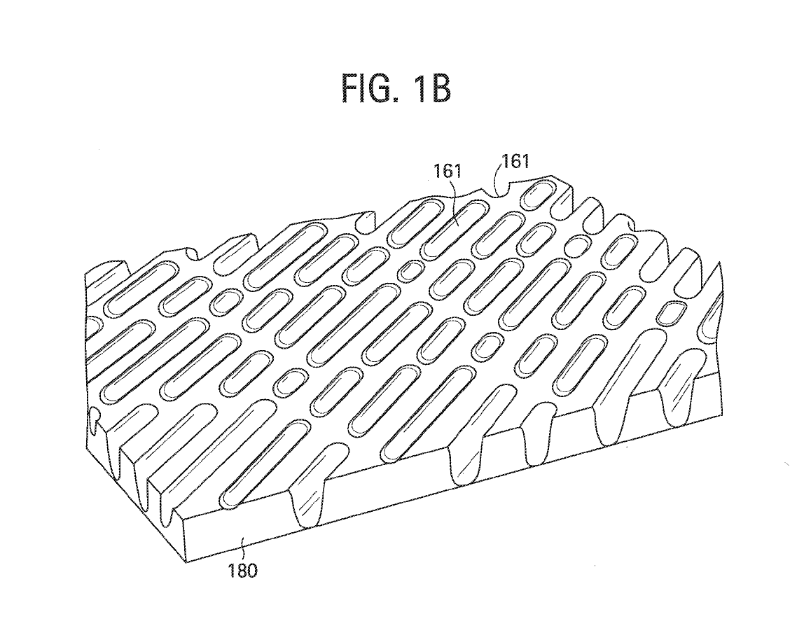

FIG. 1(a) is a scanned SEM image of an exemplary “Sharklet” topography according to an embodiment of the invention sized to resist algae adhesion and growth. The Sharklet topography is based on the topography of a shark's skin. Shark skin is a prominent example of a low friction surface in water. Unlike real shark skin which has fixed topographical feature dimensions based on the species, the Sharklet topography is scalable to any topographical feature dimension including feature width, feature height, feature geometry, and spacing between features. The composition of real shark skin is limited to the natural composition of the skin. The Sharklet topography according to the invention can be produced in a variety of material including synthetic polymers, ceramics, and metals, as well as composites.

The Sharklet and related topographies according to the invention can be described quantitatively using two sinusoidal functions. This description is provided below.

Surface layer comprises a plurality of features 111 which are attached to and project out from base surface 130. Base surface 130 can be a roofing material, the inner surface of a water inlet pipe for a power or water treatment plant, an implantable medical device or material, such as a breast implant, a catheter or a heart valve. Each of the features 111 have at least one microscale dimension, with a width of about 3 μm, lengths of from about 3 to about 16 μm, and a feature spacing of about 1.5 μm. The thickness (height) of features 111 comprising coating layer is about three (3) microns.

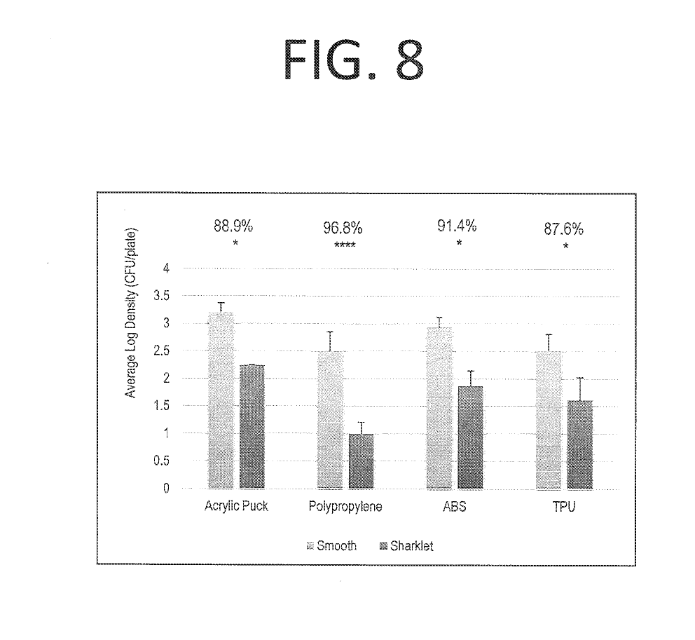

Features adjacent to a given feature 111 generally provide substantially different dimensions, in the arrangement shown in FIG. 1(a), feature lengths. The top surface of the features is shown as being planar. The patterned coating layer generally resists algae as compared to a generally planar base surface as described in the Examples and shown in FIGS. 8(a)-(c).

FIG. 1(b) is a scanned optical profilometry image of a pattern having a plurality of features 161 projecting into a base surface 180, according to another embodiment of the invention. Features 161 comprise indented void volumes into base surface 180. Although not shown, a surface can include regions having raised features 111 shown in FIG. 1(a) together with regions having indented features 161 shown in FIG. 1(b).

The composition of the patterned surface shown in FIGS. 1(a) and 1(b) is generally a polymer such as polymethylsiloxane (PDMS) elastomer SILASIC T2® provided by Dow Corning Corp, which is an elastomer of a relative low elastic modulus. The features 111 need not be formed from a single polymer. Features can be formed from copolymers and polymer composites. In another embodiment, the surface or coating comprises of a material such as, steel or aluminum, or a ceramic. The coating layer is also typically hydrophobic, but can also be neutral or hydrophilic.

The patterned surface can be formed or applied using a number of techniques, which generally depend on the area to be covered. For small area polymer layer applications, such as on the order of square millimeters, or less, techniques such as conventional photolithography, wet and dry etching, additive manufacturing, 3D printing and ink-jet printing can be used to form a desired polymer pattern. When larger area layers are required, such as on the order of square centimeters, or more, spray, dipcoat, hand paint or a variant of the well known “applique” method be used. These larger area techniques would effectively join a plurality of smaller regions configured as described above to provide a polymer pattern over a large area region, such as the region near and beneath the waterline of a ship.

A paper by Xia et al entitled “Soft Lithography” discloses a variety of techniques that may be suitable for forming comparatively large area surfaces according to the invention. Xia et al. is incorporated by reference into the present application. These techniques include microcontact printing, replica molding, microtransfer molding, micromolding in capillaries, and solvent-assisted micromolding, which can all generally be used to apply or form topographies according to the invention to surfaces. This surface topography according to the invention can thus be applied to devices as either a printed patterned, adhesive coating containing the topography, or applied directly to the surface of the device through micromolding.

Another tool that can be used is the Anvik HexScan® 1010 SDE microlithography system which is a commercially available system manufactured by Anvik Corporation, Hawthorne, N.Y. 10532. Such a tool could be used to produce surface topographies according to the invention over a large area very quickly. It has a 1 micron resolution which can produce our smallest pattern at a speed of approximately 90 panels (10″ by 14″) per hour.

Yet another tool that can be used is the OWL Nano 3D printer which is a commercially available system manufactured by Old World Laboratories, Virginia Beach, Va. It has a sub-1 micron resolution which can produce our smallest pattern at a speed of approximately 90 panels (10″ by 14″) per hour.

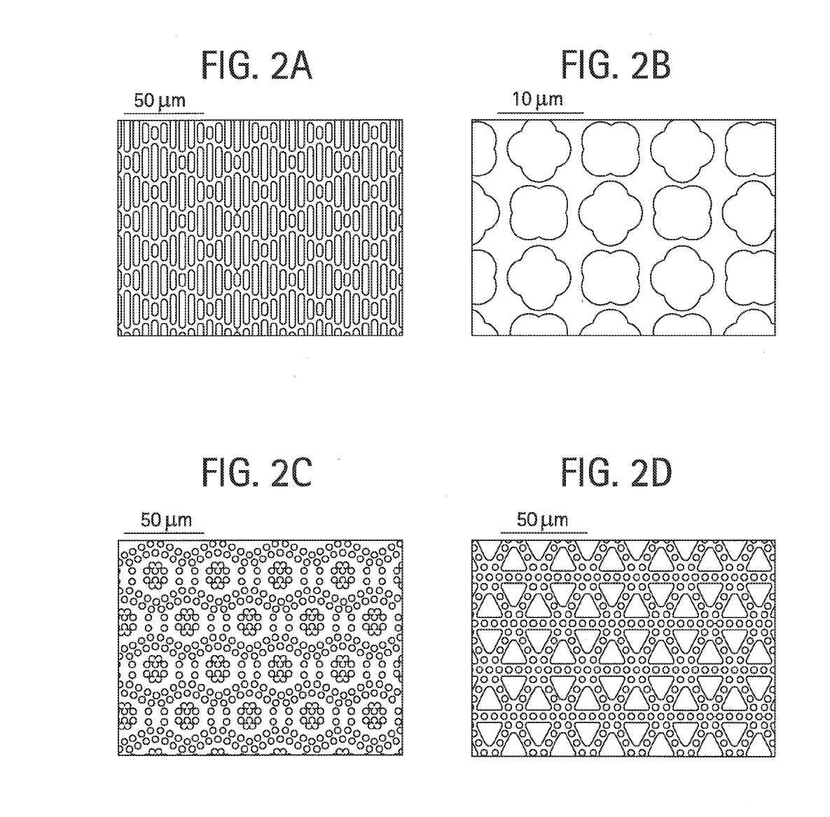

FIGS. 2(a)-(d) illustrate some exemplary architectural patterns (unit cells) that can be used with the invention. FIG. 2(a) shows a riblet pattern fabricated from PDMS elastomer having features spaced about 2 μm apart on a silicon wafer. The features were formed using conventional photolithographic processing. FIG. 2(b) shows a star/clover pattern, FIG. 2(c) a gradient pattern, while FIG. 2(d) shows a triangle/circle pattern.

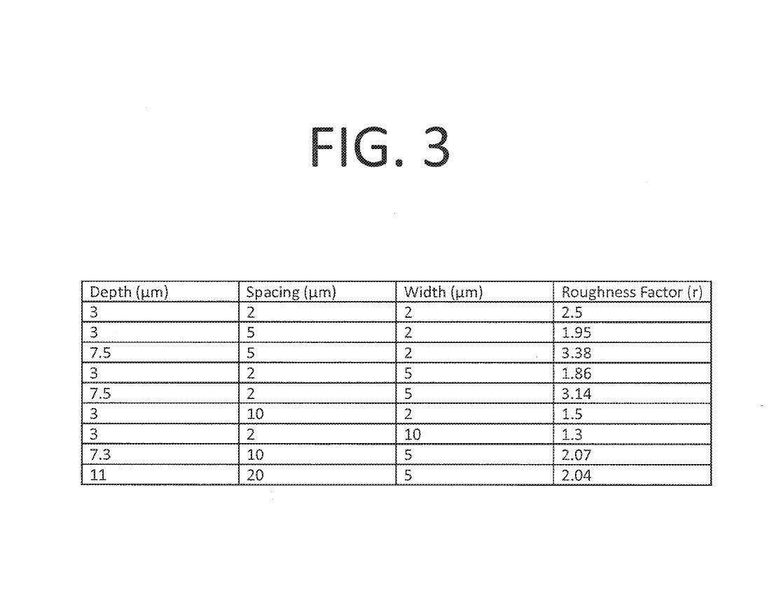

FIG. 3 provides a table of exemplary feature depths, feature spacings, feature widths and the resulting roughness factor (R) based on the patterns shown in FIGS. 2(a)-(d). Regarding the riblet pattern shown in FIG. 2(a) for the depth, spacing and widths shown, the resulting pattern roughness factor (R) ranged from 5.0 to 8.9. Similar data for the star/clover pattern (FIG. 2(b)), gradient pattern (FIG. 2(c)), and triangle/circle (FIG. 2(d)) are also shown in FIG. 3. Regarding the triangle/circle arrangement (FIG. 2(d)), for a feature depth of 10 μm, feature spacing of 1 μm, and feature width of 1 μm (circles) and 5 μm (triangles), a roughness factor (R) of 13.9 is obtained.

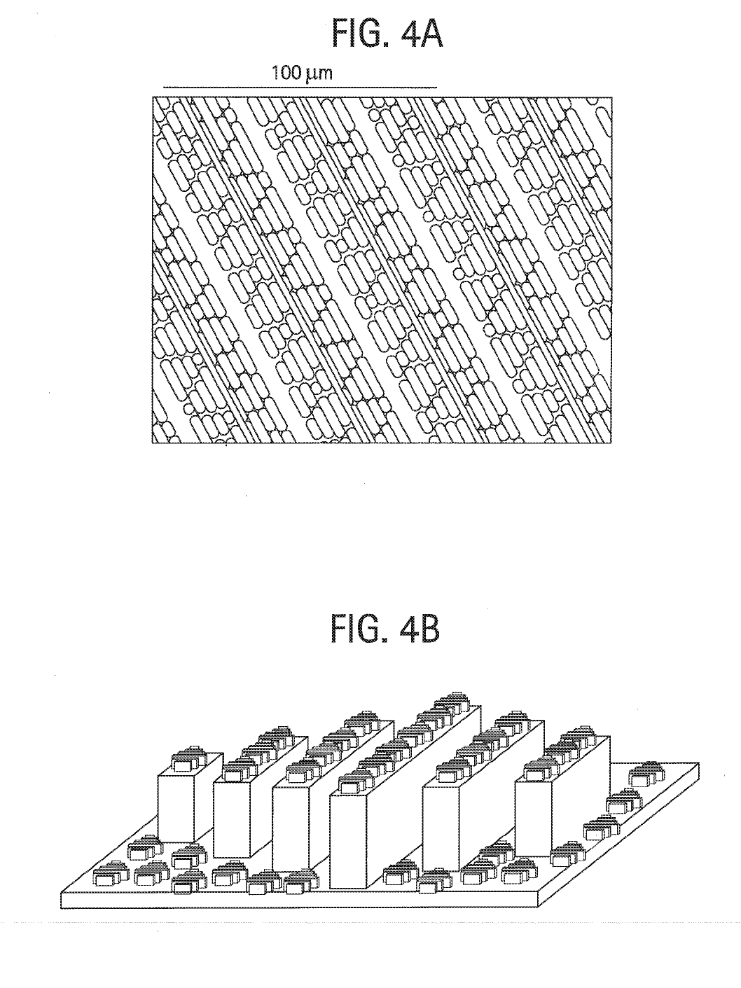

FIG. 4 is a scanned SEM image of an exemplary hierarchical (multi-layer) surface architecture according to an embodiment of the invention. The first feature spacing distance of about 2 μm between features 412 and its neighboring features including feature 411 is for deterring a first organism, or organism in a size range of about 5 μm, or less. For example, as noted above, an algae spore is nominally 5 μm wide. A patterned second layer comprising a plurality of striped plateau regions 420 is disposed on the first layer. A spacing distance between elements of the plateau layer provide a second feature spacing which is substantially different as compared to the first feature spacing. As used herein, a “substantially different spacing distance” is at least 50% larger, and is preferably at least 100% larger than the smaller first feature spacing distance. In FIG. 4, the architecture shown provides a spacing distance between the second pattern strips of about 20 μm, or about 900% greater than the first spacing distance. The 20 μm spacing is approximate ½ the width (smallest dimension) of a nominal barnacle thus repelling barnacles. Thus, hierarchical (multi-layer) surface architectures according to the invention can simultaneously repel multiple organisms covering a significant range of sizes.

In one embodiment of the invention, the surface topography is a topography that can be numerically represented using at least one sinusoidal function. In the paragraphs below, a sinusoidal description of Sharklet and related topographies is provided.

The Sharklet and related topographies can be numerically representing using two (2) sinusoidal waves. A general equation is provided which the only topographical restriction is that two elements with at least a one dimensional length discrepancy must be selected and periodic throughout the structure. The smallest feature of the two being related to the size of the smallest dimension (the width) of the organism of interest. All the elements and features in-between and/or around the two periodic features becomes irrelevant. Examples of each of these instances are presented and the generalized equation is then developed.

The Sharklet shown in FIG. 1(a) will be used for this example. The dimensions are not relevant as this point. The Sharklet shown in FIG. 1(a) is a 4-C element (repeating) structure.

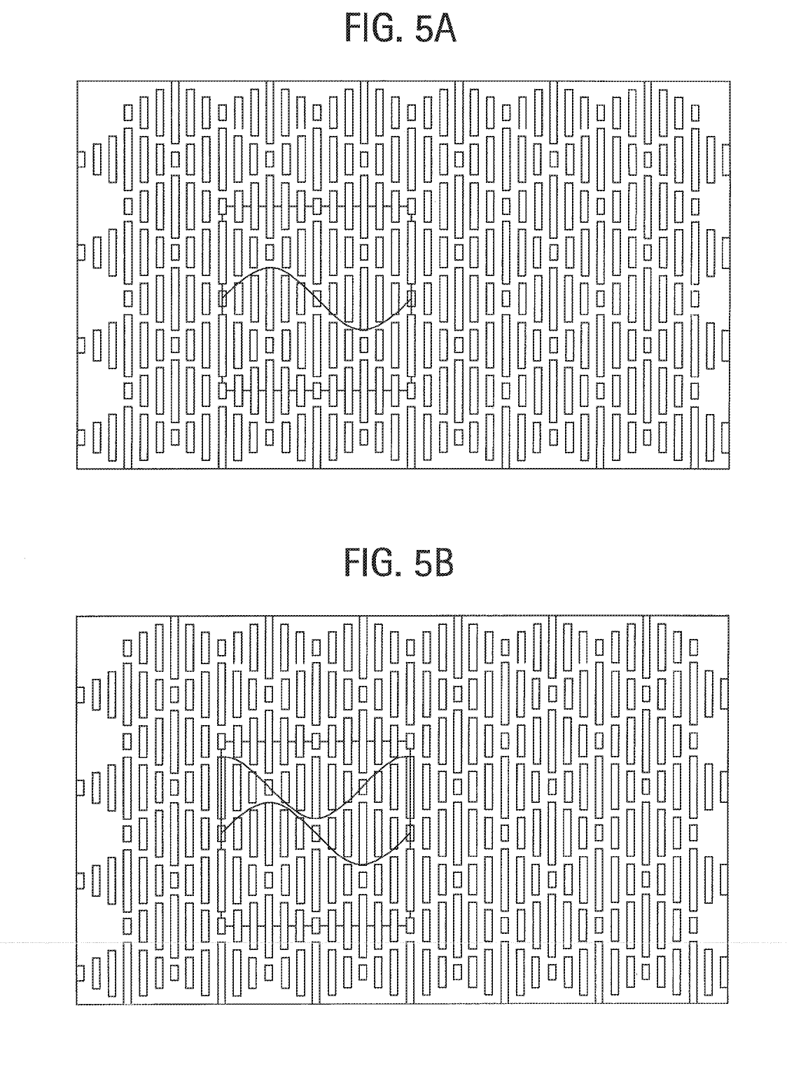

FIG. 5(a) shows a sinusoidal wave beginning at the centroid of the smallest of the four Sharklet features. By inspection of the periodicity of the Sharklet features, a sine wave of the form y=A sin(wx) can be used to describe this periodicity as shown in FIG. 5(a). It can be noticed that the repeating structure above the section described by the sin wave is out of phase from that structure by 90 degrees or π/2 radians, which happens to be a cosine wave. That periodicity and packing can be represented using a cosine wave in the form y=B+A cosine (wx) (as shown in FIG. 5(b)).

The entire surface area of the topography can be numerically represented by a numerical summation of both sinusoidal waves in the form: y=cN+A sin(wx) y=cN+B+A cosine(wx) where N=0, 1, 2, 3 . . . n

The area of coverage of the topography is thus described by the limits of n and x.

The Sharklet and related topographies can thus be defined by the following limitations:

Two geometric features of at least one dimensional discrepancy must be periodic throughout the structure.

The smallest of the two geometric features is related to the smallest dimension of the fouling organism or cell of interest.

In a standard Cartesian coordinate system represented by x and y, with the origin positioned at start of each sin and cosine wave, the smaller of the two features is periodic where the waves cross y=0. The waves pass through the area centroid of the feature @ y=0.

In a standard Cartesian coordinate system represented by x and y with the origin positioned at start of each sin and cosine wave, the larger of the two features is periodic where the waves cross reaches it's maximum amplitude. The wave intersects the center of the tallest part of the feature @ y=max and the x-moment of inertia of the feature @ y=0.

General Form of Sinusoids

y=cN+A sin(wx)

y=cN+B+A cosine(wx) where N=0,1,2,3 . . . n

The following equations define the values for the variables A, B, c and w:

A=(½)*(L_{D})
L_{D}=y-dimension of larger of two elements B=(½)*(S_{D})+(P_{S})+(½)*(L_{D})
S_{D} y-dimension of smaller of two elements
P_{S}=y-spacing between the two elements after packing c=L_{D}+2*(P_{S})+S_{D} w=2π
f=(2π)/(7)→w: angular frequency (rad), f: frequency (Hz), T: wave period
T=2*X_{D}
X_{D}=x-dimensions from centroid of smaller feature to the center of the tallest point on the larger feature Example Units=microns

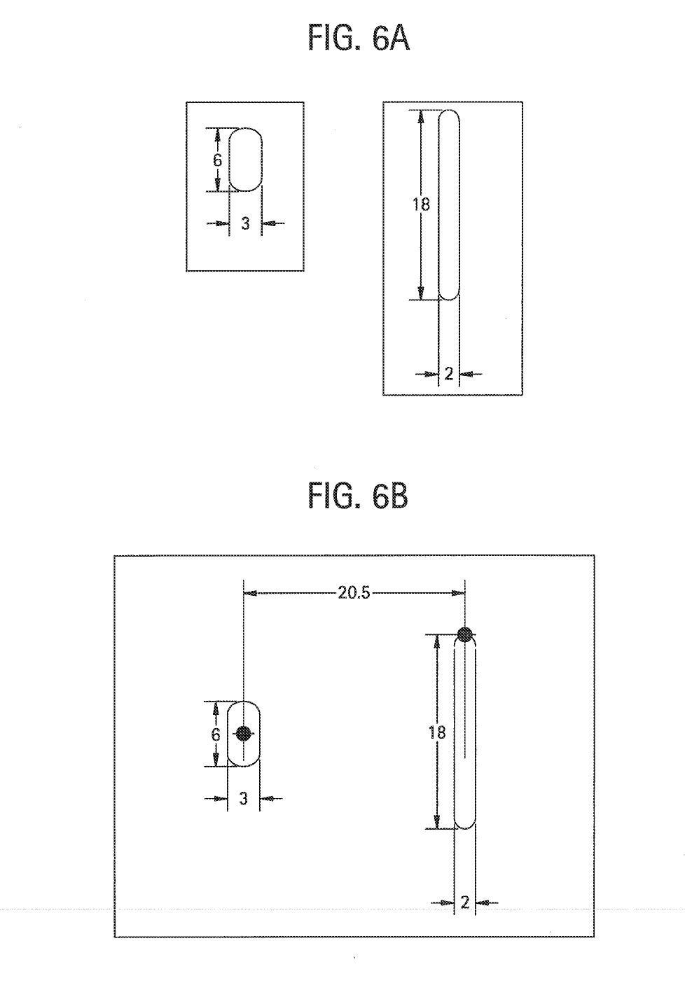

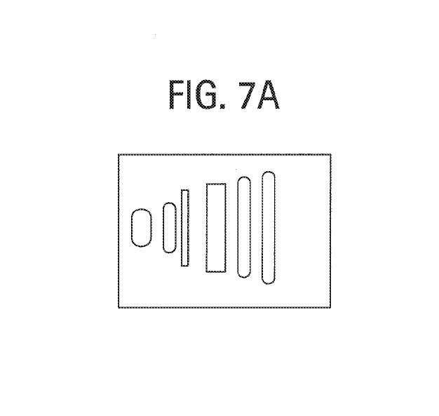

FIG. 6(a) shows element 1 and element 2. FIG. 6(b) shows the resulting layout after following limitations 3 & 4 and defining X_{D}. P_{S} (y-spacing between smaller element and larger element after packing) are then set to 3 microns as shown in FIG. 6(c).

Variables are then calculated:

A=(½)*(18)=9

B=(½)*(6)±(3)+(½)*(18)=15

c=18+(2)*(3)+9=33

w=(2π)/(2*20.5)=π/20.5

Sinusoids are then defined.

y=33N+9 sin((n/20.5)x) (1)

y=33N+15+9 cosine((π/20.5)x) (2)

where N=0, 1, 2, 3 . . . n

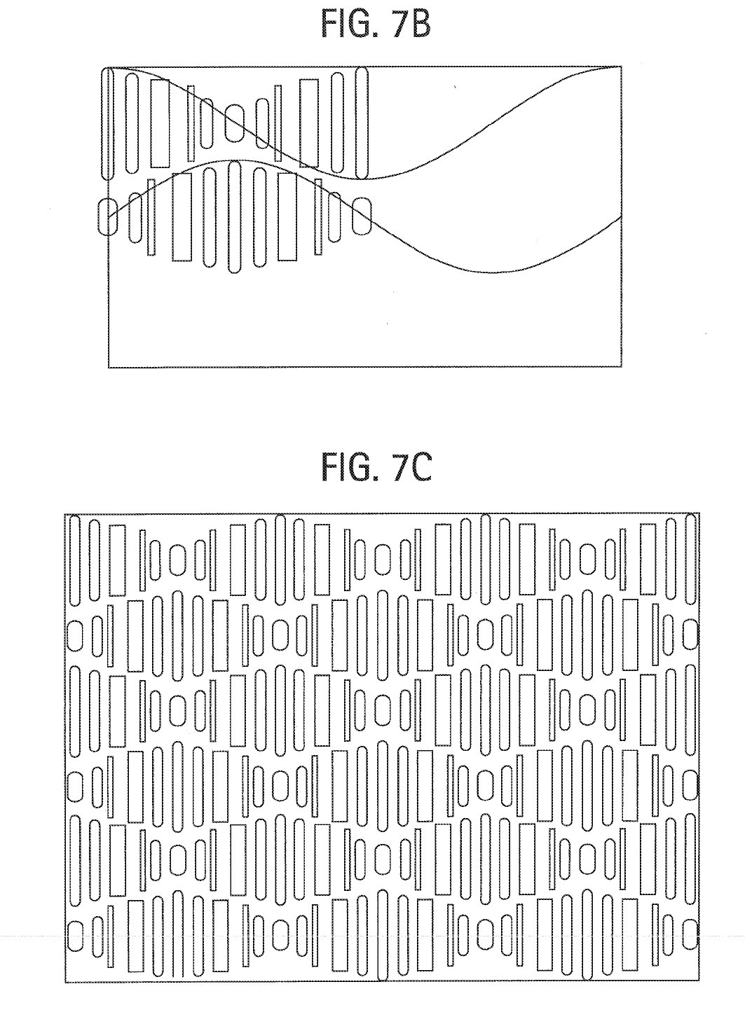

The space is then filled with elements between defined elements as shown in FIG. 7(a). Sinusoidal waves are then applied to define periodic repeat definitions as shown in FIG. 7(b) to create the desired topographical structure over the desired surface area shown in FIG. 7(c).

Another method for describing surface topographies according to the invention involves a newly devised engineered roughness index (ERI), first conceived of and used by the present Inventors. The ERI can characterize the roughness of an engineered surface topography. The ERI was developed to provide a more comprehensive quantitative description of engineered surface topography that expands on Wenzel's roughness factor (Wenzel R N. 1936, Resistance to solid surfaces to wetting by water. Ind Eng Chem 28:988-944). It has been found that Wenzel's description alone does not adequately capture the tortuosity of the engineered topographies studied. ERI is expressed as follows: ERI=(r*df)/f_{D} (1) wherein the ERI encompasses three variables associated with the size, geometry, and spatial arrangement of the topographical features: Wenzel's roughness factor (r), depressed surface fraction (f_{D}), and degree of freedom for movement (df).

Wenzel's roughness factor refers to the ratio of the actual surface area to the projected planar surface area. The actual surface area includes areas associated with feature tops, feature walls, and depressed areas between features. The projected planar surface area includes just the feature tops and depressions.

The depressed surface fraction (f_{D}) is the ratio of the recessed surface area between protruded features and the projected planar surface area. This depressed surface fraction term is equivalent to both 1−φ_{S} and 1−f₁ where φ_{S} is the surface solid fraction as described by Quere and colleagues (Bico J, Thiele U, Quere D. 2002. Wetting of textured surfaces. Colloids Surf A: Physicochem Eng Aspects 206:41-46; Quere D. 2002. Rough ideas on wetting. Physica A: Stat Theoret Phys 313:32-46) and f1 is the solid-liquid interface term of the Cassie-Baxter relationship for wetting (Cassie A B D, Baxter S. 1944. Wettability of porous surfaces, Trans Faraday Soc 40:546-551).

The degree of freedom for movement relates to the tortuosity of the surface and refers to the ability of an organism (e.g. Ulva spore or barnacle) to follow recesses (i.e. grooves) between features within the topographical surface. If the recesses form a continuous and intersecting grid, movement in both the x and y coordinates is permitted and the degree of freedom is 2. Alternatively, if the grooves are individually isolated (e.g. as in channel topographies) then movement is only allowed in one coordinate direction and the degree of freedom is 1.

As such, as described in detail below, larger ERI values correlate with reduced settlement. In a preferred embodiment, the ERI is at least 5, and is preferably 8 or more.

A related surface description according to another embodiment of the invention comprises a polymer layer having a surface. The polymer layer is an elastomer containing a plurality of dissimilar neighboring protruding non-planar surface features where for repelling algae, the features are spaced between 0.5 and 5.0 microns. The features are such that the stress required to bend the feature is >10% greater than the stress required to strain a cell wall and where the features have a greater than 10% bending modulus difference in the bending modulus between two neighboring features, or in the case of three, or more neighboring features, their vector equivalence difference of >10%. Preferably, the surface features exist on the surface at a features per area concentration of >0.1 square microns.

In one embodiment, the surface topography exhibits optical properties which allow for the transmission of visible light. The surface topography comprises a pattern defined by a plurality of spaced apart features attached to or projected into said base article. The size of the respective features and the distance between adjacent features is selected to enable a desired amount of light transmission.

In one embodiment, the distance between adjacent features is equal to or greater than 5 μm as measured between the center points of each respective feature, specifically equal to or greater than 10 μm, specifically equal to or greater than 15 μm, more specifically equal to or greater than 20 μm, even more specifically equal to or greater than 25 μm.

In another embodiment, each feature has a width of equal to or greater than 2 μm, specifically equal to or greater than 5 μm, specifically equal to or greater than 10 μm, more specifically equal to or greater than 15 μm, even more specifically equal to or greater than 20 μm.

In yet another embodiment, the distance between adjacent features is equal to or greater than 5 μm as measured between the center points of each respective feature, specifically equal to or greater than 10 μm, and each feature has a width of equal to or greater than 2 μm.

In still yet another embodiment, the distance between adjacent features and/or each feature has a width that is equal to or greater than 5 μm.

In one embodiment, the surface topography has an optical transmission of visible light (400 nm to 700 nm), specifically 600 nm, of equal to or greater than 70%, specifically equal to or greater than 80%, more specifically equal to or greater than 85%, even more specifically equal to or greater than 90%, and even more specifically equal to or greater than 95% as measured by ASTM D1003-13 Procedure B (Spectrophotometer Method).

In another embodiment, the surface topography has a haze of equal to or less than 85% as measured by ASTM D1003-13 Procedure B (Spectrophotometer Method), specifically equal to or less than 75%, more specifically equal to or less than 50%, and even more specifically equal to or less than 35%.

In yet another embodiment, the surface topography has a total luminous transmittance of equal to or less than 100% as measured by ASTM D1003-13 Procedure B (Spectrophotometer Method), specifically equal to or less than 98% and more specifically equal to or less than 95%.

In still another embodiment, the surface topography has a diffuse transmittance of equal to or less than 60% as measured by ASTM D1003-13 Procedure B (Spectrophotometer Method), specifically equal to or less than 50% and more specifically equal to or less than 40%.

The invention provides numerous benefits to a variety of applications since surface properties can be customized for specific applications. The invention can provide reduced energy and cost required to clean surfaces of biofouling by reducing biofouling in the first place. As a result, there can be longer times between maintenance/cleaning of surfaces. As explained below, the invention can also provide non-capsule formation due to foreign body response in the case of coated implanted articles. The invention can also be configured to provide enhanced adhesion to surfaces.

The present invention is thus expected to have broad application for a variety of products. Exemplary products that can benefit from the bioadhesion resistance provided by coating architectures according to the invention include, but are not limited to, the following:

a. screen protectors for touch screens on electronic products, e.g., Smart phones and tablets;

biomedical implants, such as breast plant shells or other fluid filled implant shells;

b. biomedical instruments, such as heart valves;

c. Hospital surfaces, e.g., consider film (electrostatic) applications to surfaces that can be readily replaced between surgeries;

d. Clothing/protective personal wear;

e. Biomedical packaging;

f. Clean room surfaces, such as for the semiconductor or biomedical industry;

g. Food industry, including for packaging, food preparation surfaces;

h. Marine industry-including exterior surfaces of marine vessels including ships and associated bilge tanks and gray water tanks and water inlet/outlet pipes;

i. Water treatment plants including pumping stations;

j. Power plants;

k. Airline industry;

l. Furniture industry, such as for children's cribs;

m. Transportation industry, such as for ambulances, buses, public transit, and

n. Swimming pools

### EXAMPLES

It should be understood that the Examples described below are provided for illustrative purposes only and do not in any way define the scope of the invention.

In the investigation with the bacteria Staphylococcus aureus, Sharklet topography with 2 μm spacing dimensions was chosen to accommodate isolated, individual bacterium (cell size ^{˜}1-2 μm) to prohibit connectivity between bacteria cells thus prohibiting the formation of a confluent biofilm.

A first assay was conducted to determine the average log density of Staphylococcus aureus contamination from a contaminated cloth on samples having either a smooth surface topography or the Sharklet pattern surface topography. The respective sample surfaces were prepared using acrylic, polypropylene, acrylonitrile butadiene styrene (ABS) or thermoplastic polyurethane (TPU) cast against nickel shims (unpatterned smooth surface control) or further embossed with the Sharklet surface topography.

Topographies used included a smooth surface with no pattern thereon (SM) and a surface having a 2×2 pattern where the width of the features is 2 μm and the distance between the features is 2 μm (SK2×2). The depth of each feature was 3 μm. Each sample was firmly adhered to the bottom of a petri dish, sterilized for 10 minutes with 95% ethanol, rinsed three times with deionized water and allowed to dry prior to exposure and testing.

The results are shown in the chart in FIG. 8. Error bars represent ±1 standard error. As may be seen from the chart in FIG. 8, the samples having the Sharklet topography all exhibited significantly less microbial contamination after exposure than the smooth surface topographies, for each of the respective materials employed.

A second assay was conducted to determine the average log density of Staphylococcus aureus (MSSA) or methicillin-resistant Staphylococcus aureus (MRSA) microbial attachment using a bacterial suspension immersion with RODAC recovery technique on samples having different topographies.

The respective sample surfaces were prepared as described above using an acrylic film (available from Flexcon, Spenser, Mass.) cast against nickel shims (unpatterned smooth surface control) or further embossed with the same Sharklet surface topography described above.

Bacterial inoculations of MSSA or MRSA ranging from 1×103 to 1×104 CFU/ml completely submerged the test samples in the petri dish for 1 hour at room temperature. The bacterial suspension was then removed, and the dishes were rinsed with sterile 1×PBS three times, for 10 seconds while rotating at 80 rpm to remove the non-attached cells. After discarding the final rinsate, the sample surfaces were dried under ambient conditions for one hour and the samples were evaluated for viable bacteria using RODAC contact agar plates (BBL Prepared RODAC Plate, Trypticase Soy Agar with Lecithin and Polysorbate 80). The RODAC contact agar plates were pressed onto the inoculated surfaces for five seconds and then incubated at 37° C. for 18-24 hours. The plates were photographed and counted, and the results were quantified, log transformed and recorded.

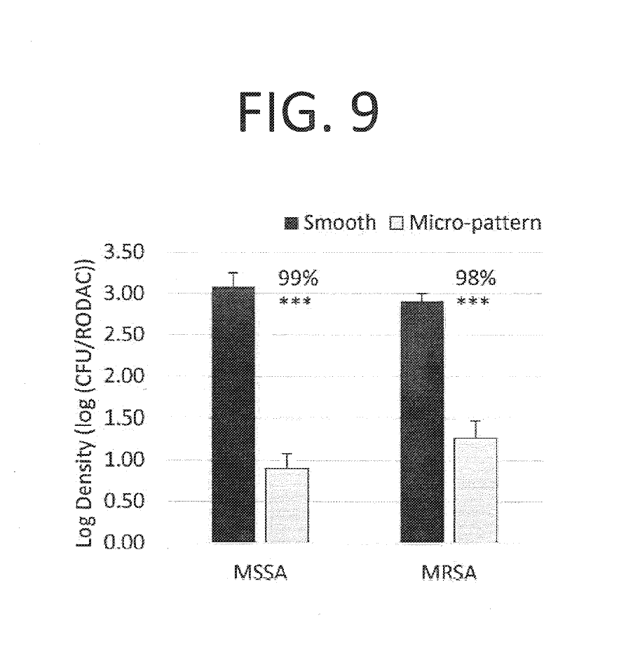

The results are shown in the chart in FIG. 9. The plot represents average log densities and standard error of the mean. Error bars represent ±1 standard error. Significance was determined using a single T-test of the log reduction data points. The average log reduction data values were then used to calculate the median percent reduction values indicated above each column in FIG. 9 (***), with p<0.005. As may be seen from the chart in FIG. 9, the samples having the Sharklet surface topography all exhibited significantly less MSSA and MSRA microbial attachment after exposure than samples having the smooth surface topographies, specifically a 98-99% reduction in MSSA and MRSA, respectively.

A third assay was conducted to determine the average log density of MSSA microbial persistence on samples having different topographies after a uniform spray inoculation technique. The uniform spray inoculation technique mimics a common surface contamination event. The respective sample surfaces were prepared as described above using an acrylic film cast against nickel shims (unpatterned smooth surface control) or embossed with the same Sharklet surface topography described above. Each sample was firmly adhered to the bottom of a petri dish, sterilized for 10 minutes with 95% ethanol, rinsed three times with deionized water and allowed to dry prior to exposure and testing.

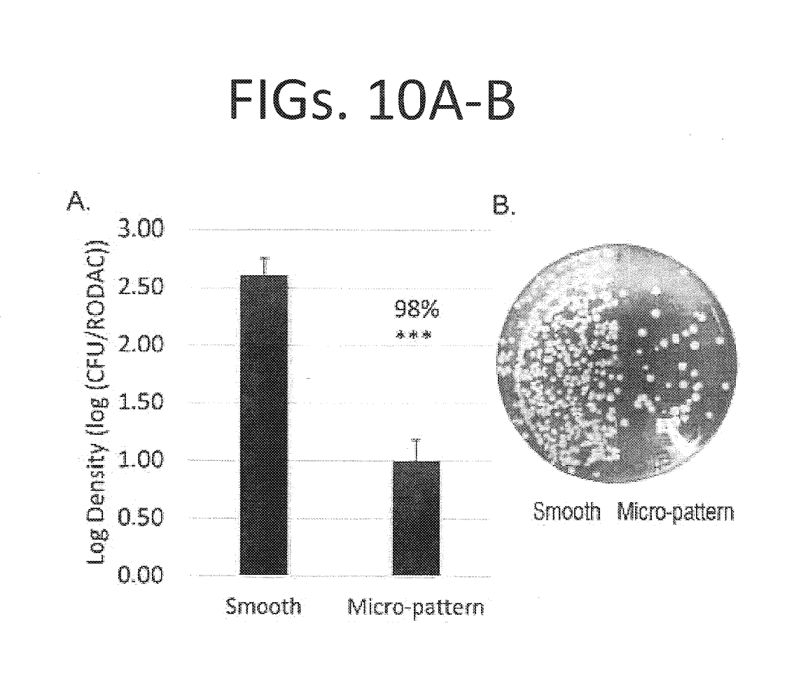

Bacterial suspensions ranging from 1×10⁵ to 1×10⁷ CFU/ml were sprayed onto test surfaces cut into 40 mm radius semi-circular shapes placed in a petri dish using a sterilized Central Pneumatic Professional® gravity-fed paint sprayer (available from Harbor Freight Tools, Camarillo, Calif.). Following 30 minutes of drying under ambient conditions, RODAC sampling was conducted as described above. The results are shown in the chart in FIG. 10A.

As may be seen from the chart in FIG. 10A, the sample having the Sharklet topography exhibited significantly less microbial attachment after exposure than the smooth surface topography, specifically a 98% reduction in MSSA.

This reduction is also visually apparent from the representative image of a RODAC contact plate after MSSA sampling in FIG. 10B. As may be seen from the image in FIG. 10B, the surface having the Sharklet topography (right) has significantly fewer bacteria than the smooth surface topography (left).

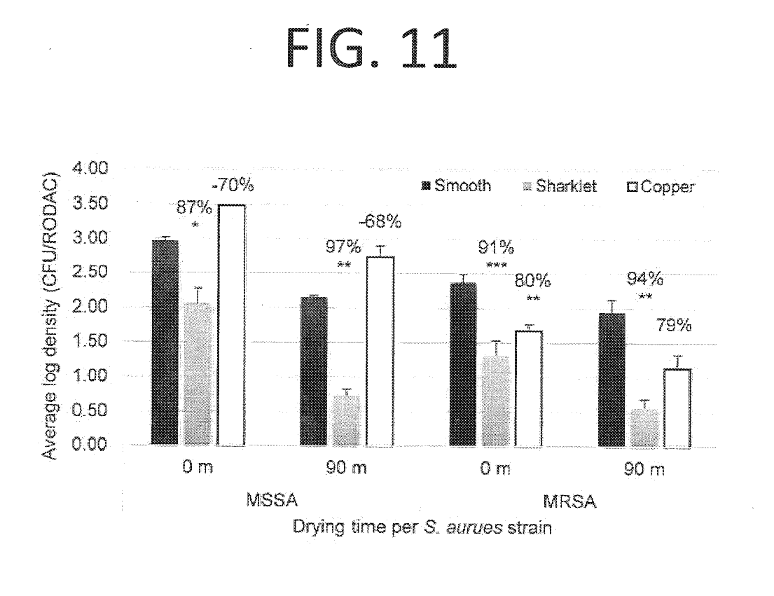

A fourth assay was conducted to determine the average log density of MSSA or MRSA microbial transfer and persistence on the above-described samples using the uniform spray inoculation technique described above with time points sampled after 0 and 90 minutes of drying. In addition to the acrylic film samples described above, an additional sample using copper foil as a material was also evaluated (a 99.9% pure alloy available from Alaskan Copper and Brass Company, Seattle, Wash. and registered as US EPA antimicrobial). The results are shown in the chart in FIG. 11.

As may be seen from the chart in FIG. 11, the sample having the Sharklet topography exhibited significantly less microbial attachment after exposure than the smooth surface topography and the copper surface. More specifically, the results in FIG. 11 show that the transfer (at 0 minutes) of MSSA onto the acrylic film having the Sharklet pattern was reduced 87% compared to the smooth surface. MSSA persistence (at 90 minutes) on the Sharklet pattern was further reduced 97% compared to the smooth surface. Similar results are exhibited for the samples exposed to MRSA, which show a 91% reduction in transfer and a 94% reduction in persistence for the Sharklet topography compared to the smooth surface.

The results further show that the sample having the Sharklet topography is significantly more effective at reducing MSSA or MRSA transfer and persistence than the smooth surface or the copper surface.

Moreover, the results in FIG. 11 further show that copper, which is marketed for its ability to reduce environmental contamination, was not effective at reducing MSSA contamination, and was significantly less effective than the Sharklet topography. In another assay, in the investigation with the bacteria Staphylococcus aureus, samples of 2 μm Sharklet PDMSe, smooth PDMSe, and glass were statically exposed to 10⁷ CFU/mL in growth medium for up to 12 days to promote biofilm formation. Samples were removed on the 2^{nd}, 4^{th}, 7^{th}, and 12^{th} days, gently rinsed by immersion in de-ionized water, and air-dried for characterization.

After 12 days, scanning electron micrographs (SEM) revealed abundant biofilm on glass and slightly less on the smooth PDMSe, but no evidence of biofilm on the Sharklet surface. The SEM images acquired also suggest inhibition of bacterial cell settlement on the Sharklet surface.

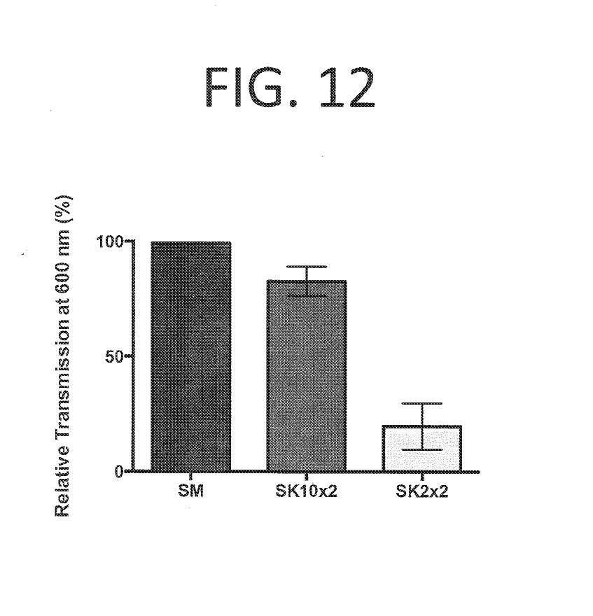

Another experiment was conducted to determine the relative light transmission of visible light at 600 nm using different surface topographies. The topographies used included a smooth surface with no pattern thereon (SM), a surface having a 10×2 pattern where the width of the features is 2 μm and the distance between the center points of adjacent features is 10 μm (SK10×2) and a surface having a 2×2 pattern where the width of the features is 2 μm and the distance between the features is 2 μm (SK2×2). Thin films of the respective surface topographies were prepared and adhered to the side of a cuvette. An empty cuvette with no film adhered thereto was used for the smooth (SM) surface topography as a control. Smooth acrylic and polyester-based films were also prepared and analyzed. The results of each of the smooth (SM) surface topographies are grouped together in the chart in FIG. 12. The SK10×2 surface topography was prepared using a polyester-based film. The SK2×2 surface topography was prepared using an acrylic-based film.

The transmission of visible light at 600 nm of each of the surface topographies was measured through the cuvettes using a CO8000 Cell Density Meter. The light transmission was recorded as a percentage for each of three surface topographies. The results are shown in the chart in FIG. 12. Error bars represent ±1 standard error.

As can be seen from the chart in FIG. 12, the smooth surface topographies all exhibited the same amount of light transmission. The SK10×2 surface topography exhibited a light transmission of 76% compared to the SK2×2 surface topography and the SM surface topography. The results in the chart in FIG. 12 thus demonstrate that a surface topography in which the width of the features is 2 μm or greater and/or the distance between the center points of adjacent features is 10 μm or greater reduces light diffraction and significantly increases light transmission compared to the SK2×2 surface topography.

Another experiment was conducted to determine the total luminous transmittance for different surface topographies as measured according to ASTM D1003-13 Procedure B (Spectrophotometer Method). A BYK Gardner® TCS Plus Spectrophotometer was used as the spectrophotometer used according to test procedure ASTM D1003-13 Procedure B (Spectrophotometer Method). Topographies used included a control surface using an industry standard control material (WriteRight maximum screen protection fitted screen protector for Apple iPhone 5/5s/5c), a smooth surface with no pattern thereon (SM), a surface having a 10×2 pattern where the width of the features is 2 μm and the distance between the center points of adjacent features is 10 μm (SK10×2) and a surface having a 2×2 pattern where the width of the features is 2 μm and the distance between the features is 2 μm (SK2×2). The relative thickness of each of the surface topographies is provided below in Table 1:

TABLE 1

| Sample | Thickness (inches) |
|---|---|
| Industry Standard Control | 0.0060 |
| Material | |
| SK2x2 | 0.0037 |
| SM | 0.0033 |
| SK10x2 | 0.0032 |

The samples were analyzed in three separate runs to determine the total luminous transmittance of each respective sample. The results are shown below in Table 2.

TABLE 2

| | | Average Total |
|---|---|---|
| | Total Luminous | Luminous |
| Sample | Transmittance (%) | Transmittance (%) |
| Industry Standard | 92.56 | 92.53 |
| Control Material | 92.43 | |
| | 92.61 | |
| SK2x2 | 104.69 | 104.35 |
| | 104.30 | |
| | 104.07 | |
| SM | 91.03 | 91.26 |
| | 91.20 | |
| | 91.54 | |
| SK10x2 | 94.95 | 94.66 |
| | 94.52 | |
| | 94.52 | |

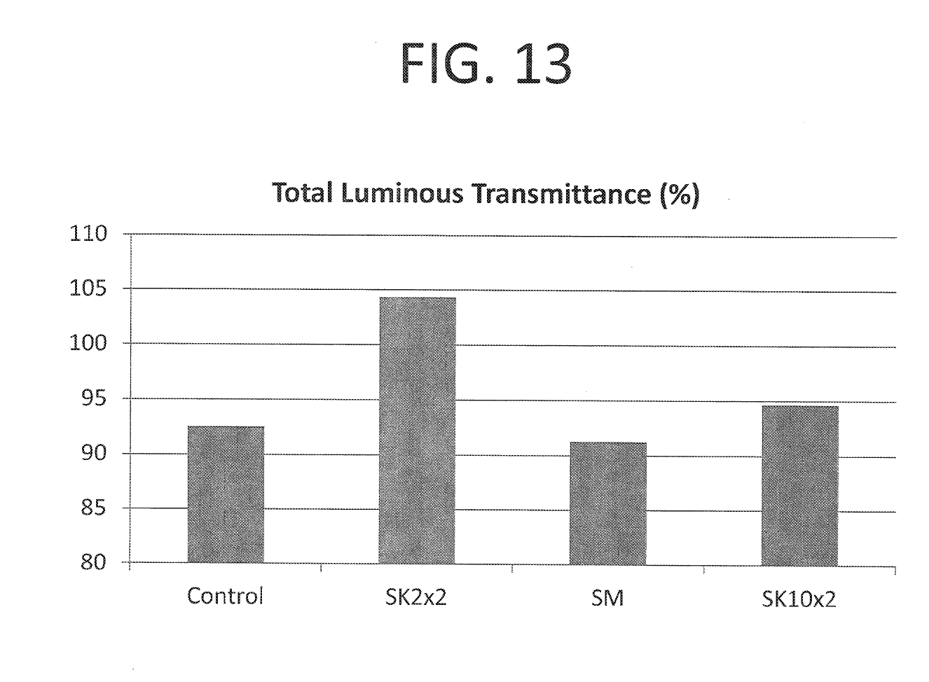

The average total luminous transmittance for each sample is plotted in the chart in FIG. 13. As can be seen from Table 2 and FIG. 13, the total luminous transmittance for the SK10×2 surface topography is significantly lower than that of the SK2×2 surface topography, and comparable to the Control and smooth (SM) surface topography.

Another experiment was conducted to determine the diffuse transmittance for different surface topographies as measured according to ASTM D1003-13 Procedure B (Spectrophotometer Method). The surface topographies were the same as those described above. The samples were analyzed in three separate runs to determine the total diffuse transmittance of each respective sample. The results are shown below in Table 3.

TABLE 3

| | Diffuse | Average Diffuse |
|---|---|---|
| Sample | Transmittance (%) | Transmittance (%) |
| Industry Standard | 1.06 | 1.26 |
| Control Material | 1.27 | |
| | 1.46 | |
| SK2x2 | 91.62 | 91.14 |
| | 91.05 | |
| | 90.73 | |
| SM | 2.26 | 2.28 |
| | 2.22 | |
| | 2.36 | |
| SK10x2 | 33.90 | 32.49 |
| | 33.18 | |
| | 30.39 | |

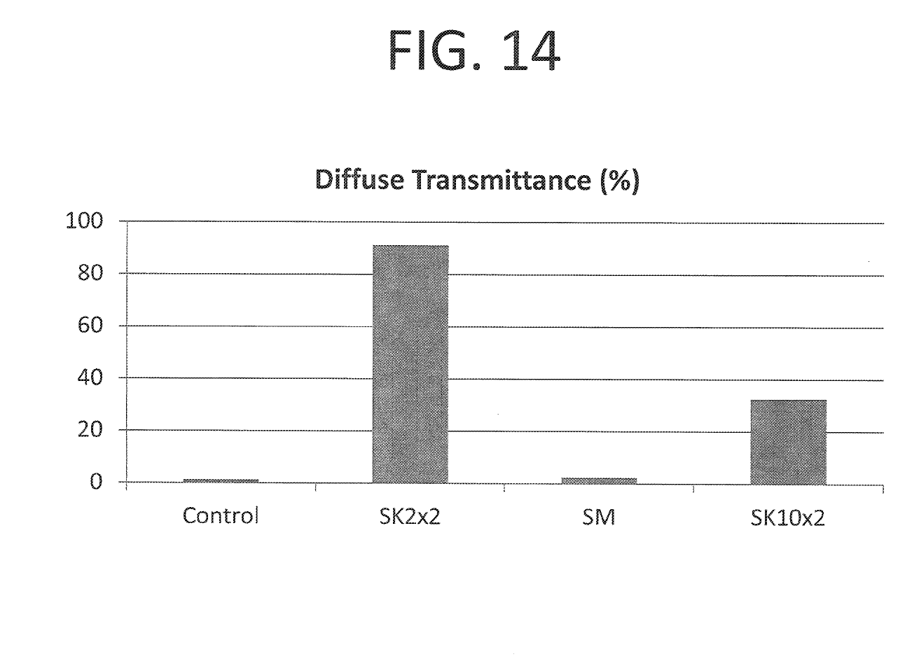

The average diffuse transmittance for each sample is plotted in the chart in FIG. 14. As can be seen from Table 3 and FIG. 14, the diffuse transmittance for the SK10×2 surface topography is significantly lower than that of the SK2×2 surface topography.

Another experiment was conducted to determine the haze for different surface topographies as measured according to ASTM D1003-13 Procedure B (Spectrophotometer Method). The surface topographies were the same as those described above. The samples were analyzed in three separate runs to determine the total diffuse transmittance of each respective sample. The results are shown below in Table 4.

TABLE 4

| Sample | Haze (%) | Average Haze (%) |
|---|---|---|
| Industry Standard | 1.15 | 1.37 |
| Control Material | 1.47 | |
| | 1.58 | |
| SK2x2 | 87.52 | 87.33 |
| | 87.30 | |
| | 87.18 | |
| SM | 2.48 | 2.50 |
| | 2.43 | |
| | 2.58 | |
| SK10x2 | 35.70 | 34.32 |
| | 35.10 | |
| | 32.15 | |

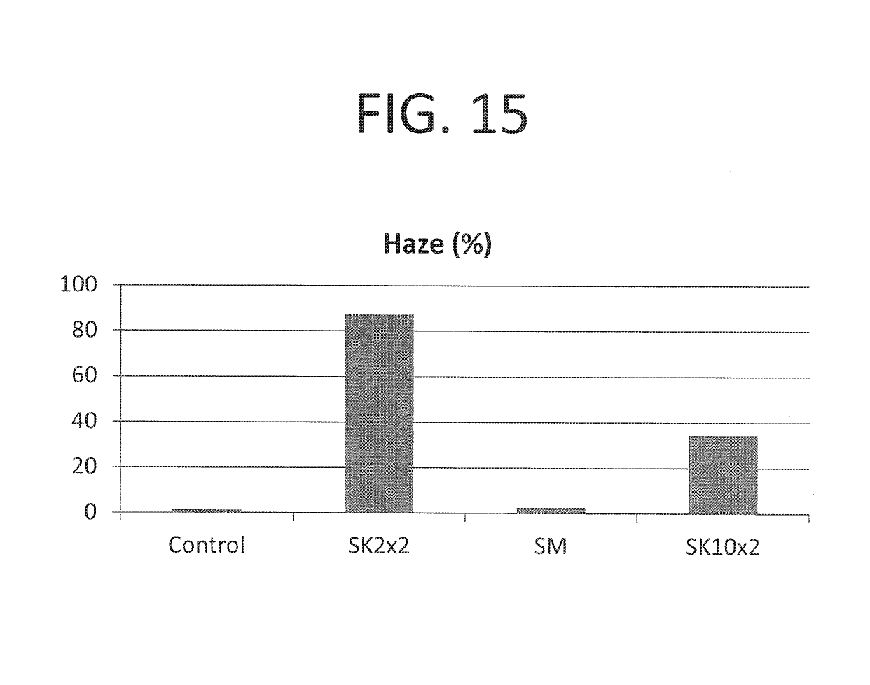

The average haze for each sample is plotted in the chart in FIG. 15. As can be seen from Table 4 and FIG. 15, the haze for the SK10×2 surface topography is significantly lower than that of the SK2×2 surface topography.

In an embodiment, the article comprises a plurality of spaced features, where the distance between adjacent features is equal to or greater than 10 micrometers (μm), preferably greater than or equal to 12 micrometers, preferably greater than or equal to 20 micrometers, preferably greater than or equal to 25 micrometers, upto a maximum value of 50 micrometers.

In another embodiment, the article comprises a plurality of spaced features, wherein each feature has a width of equal to or greater than 2 micrometers (μm), preferably greater than or equal to 3 micrometers, preferably greater than or equal to 4 micrometers, preferably greater than or equal to 5 micrometers, preferably greater than or equal to 6 micrometers, preferably greater than or equal to 8 micrometers, preferably greater than or equal to 10 micrometers, and more preferably greater than or equal to about 15 micrometers. The width can have a maximum value of 25 micrometers, and preferably have a value of less than or equal to 20 micrometers.

The article may be disposed on transparent substrates (also referred to herein as the base article). In other words, an optically transparent substrate may have disposed on it a surface that contains the texture detailed herein. The optically transparent substrate may have a transparency of greater than or equal to about 80%, preferably greater than or equal to about 90%, and more preferably greater than or equal to about 95%. In another embodiment, the optically transparent substrate may have a haze of less than 50%, preferably less than 35%, preferably less than 20%, preferably less than 10%, and more preferably less than 5%, when measured by ASTM D1003-13 Procedure B (Spectrophotometer Method).

In an embodiment, the article may be used on transparent surfaces (transparent substrates or base articles) such as windshields, lens for optical microscopes, telescopes, and the like, lens used to for the dispersion of chemical signals, and the like. In short, the surface and the substrate (the base article) may comprise a glass that comprises a metal oxide (e.g., silica, alumina, titania, zirconia, or a combination thereof).

In windshields, the article may be disposed on the outside of the windshield (i.e., the surface of the windshield facing the outside of an automobile), the inside of the windshield (i.e., the surface of the windshield facing the inside of an automobile), and/or in between two or more layers of glass that form the windshield. The ability of the article to diffract the incoming light reduces the intensity of light that is incident upon the driver.

The article may also be disposed in or on the windows of a house. This reduces the intensity of light incident upon occupants of the house when they look outside the windows. Thus the article while being optically transparent and enabling a viewer to see through it is also able to diffract incoming light and to prevent it from blinding the viewer. The ability of the article to diffract incoming light makes it useful in the chemical analysis of a light source, which permits multiple detector locations in an analytical machine to permit detection of the chemicals contained in the source of light.

The article may also be used on lenses for telescopes and microscopes to prevent bioadhesion and prevent contamination via moisture build-up. The ability of the article to prevent adhesion facilitates the draining of moisture from the surface when there is a build-up due to condensation. The article may also be used on boiling plates for condensation drainage.

It is to be understood that while the invention has been described in conjunction with the preferred specific embodiments thereof, that the foregoing description as well as the examples, which follow are intended to illustrate and not limit the scope of the invention. Other aspects, advantages and modifications within the scope of the invention will be apparent to those skilled in the art to which the invention pertains.

1. An article having a surface topography for resisting bioadhesion of organisms, the article comprising:
a base article having a surface; said surface having a topography comprising a pattern defined by a plurality of spaced apart features attached to or projected into said base article, and said plurality of spaced apart features comprising at least one feature having a substantially different geometry, wherein neighboring patterns share a common feature, the plurality of spaced apart features has at least one microscale dimension, and said surface has an optical transmission at 400 nm to 700 nm of equal to or greater than 70%.

2. The article of claim 1, wherein the surface has an optical transmission at 400 nm to 700 nm of equal to or greater than 80%.

3. The article of claim 1, wherein the surface has an optical transmission at 400 nm to 700 nm of equal to or greater than 85%.

4. The article of claim 1, wherein the surface has an optical transmission at 400 nm to 700 nm of equal to or greater than 90%.

5. The article of claim 1, wherein the surface has a haze of equal to or less than 50% as measured by ASTM D1003-13 Procedure B (Spectrophotometer Method).

6. The article of claim 1, wherein the surface has a haze of equal to or less than 35% as measured by ASTM D1003-13 Procedure B (Spectrophotometer Method).

7. The article of claim 1, wherein the surface has a haze of equal to or less than 10% as measured by ASTM D1003-13 Procedure B (Spectrophotometer Method).

8. The article of claim 1, wherein the surface has a haze of equal to or less than 5% as measured by ASTM D1003-13 Procedure B (Spectrophotometer Method).

9. The article of claim 1, wherein a distance between adjacent features is equal to or greater than 10 μm.

10. The article of claim 1, wherein each feature has a width of equal to or greater than 2 μm.

11. The article of claim 1, wherein a distance between adjacent features and/or each feature has a width that is equal to or greater than 5 μm.

12. The article of claim 1, wherein the surface comprises a tortuous path and wherein the tortuous path is defined by a sinusoidal function.

13. (canceled)

14. The article of claim 1, wherein the plurality of spaced apart features is applied to the surface in the form of a coating.

15. The article of claim 1, wherein the plurality of spaced apart features comprises an organic polymer, a ceramic or a metal.

16-22. (canceled)

23. The article of claim 1, wherein the base article comprises a glass that comprises a metal oxide.
